(19) United States
(12) Patent Application Publication
(10) Pub. No.: US 2003/0165210 A1
(43) Pub. Date: Sep. 4, 2003

(54) Nuclear reactions produced using rapid temperature changes

(76) Inventor: Ping-Wha Lin, Angola, IN (US)

Correspondence Address: BAKER & DANIELS, 111 E. WAYNE STREET, SUITE 800, FORT WAYNE, IN, 46802

(21) Appl. No.: 10/255,216

(22) Filed: Sep. 26, 2002

Related U.S. Application Data
(60) Provisional application No. 60/326,249, filed on Oct. 1, 2001.

(51) Int. Cl. G21J 1/00; G21B 1/00

(52) U.S. Cl. 376/100

(57) ABSTRACT

A method of generating a nuclear reaction from a gas stream containing water which involves heating a gas stream at a rapid rate sufficient to dissociate the water into hydrogen and oxygen and to transform hydrogen ions into protons which produce nuclear reactions, including nuclear fusion. Once the reaction state is reached, no additional heat needs to be inputted into the reaction system. The resulting nuclear reaction can be used to produce heat for buildings, heat that can be used to generate electricity, and heat that can be used for other purposes.

### Related Applications

The present application is based upon and claims priority to U.S. Provisional Patent Application Serial No. 60/326,249, filed Oct. 1, 2001.

### TECHNICAL FIELD

The present invention relates to nuclear reaction mechanisms based on the new theory of flux. More particularly, the present invention is directed to a process of rapidly heating water vapor in a gas stream in a manner that leads to nuclear reactions.

### BACKGROUND ART

According to Lin's Theory of Flux (see U.S. Pat. No. 5,084,258), when a chemical reaction system is subjected to a high time rate of temperature change, it changes from equilibrium to non-equilibrium conditions. It has been proved mathematically that, when a gas system is subjected to a high time rate of temperature increase, the activities of particles (molecules, atoms or nuclei, and electrons) are increased: the particles are accelerated; frequencies and amplitudes of electron and atomic vibrations in a molecule increase; average kinetic energy of the particles increases; atomic bonds are ruptured; and electrons are caused to leave their orbits.

According to the present invention, the inventor has discovered that his theory of flux can be applied to systems which involve nuclear reactions.

### DISCLOSURE OF THE INVENTION

According to various features, characteristics and embodiments of the present invention which will become apparent as the description thereof proceeds, the present invention provides a method of generating a nuclear reaction from a gas stream containing hydrogen atoms which involves the steps of:

a) heating the gas stream at a rapid rate sufficient to dissociate the water into hydrogen and oxygen and to transform hydrogen ions into protons to initiate nuclear reactions;

b) terminating the heating of the gas stream; and

c) allowing nuclear reactions to continue in reactive species of the gas stream.

The present invention further provides a method of generating heat which involves the steps of:

a) providing a gas stream which includes water;

b) heating the gas stream at a rapid rate sufficient to dissociate the water into hydrogen and oxygen and to transform hydrogen ions into protons;

c) terminating the heating of the gas stream; and

d) allowing nuclear reactions to occur in reactive species of the gas stream.

The resulting gas stream from the reactor which includes air and heat generated from nuclear reactions can be used for apace heating, electrical generation and other applications.

### BRIEF DESCRIPTION OF THE DRAWINGS

The present invention will be described with reference to the attached drawings which are given as non-limiting examples only, in which:

FIG. 1 is graph depicting the relationship between reaction rate and temperature for different types of chemical reactions.

FIG. 2 is schematic side view of a vertically fired combustor.

FIG. 3 is a schematic side view of a basic nuclear fusion unit according to one embodiment of the present invention.

FIG. 4 is a schematic diagram of a general arrangement of nuclear fusion system for space heating.

FIG. 5 is a schematic diagram of nuclear fusion boiler for a new power plant or for retrofitting existing power plants.

### BEST MODE FOR CARRYING OUT THE INVENTION

As an extension of Lin's Theory of Flux, it has been determined during the course of the present invention that when a chemical reaction system is subjected to a high time rate of temperature change, all or most of the electrons of various chemical species to leave their orbits to form a plasma which is very active chemically. When this occurs, the acceleration and collisions of particles (electrons, neutrons and nuclei) in the dynamic condition can lead to nuclear reactions.

During the course of the present invention pilot plant studies were conducted at Research Triangle, N.C. USA, for SO₂ conversion to SO₃ by rapid heating. In these studies, a 10-ft high vertically fired combustor (VFC) was used. Air containing 0.5% SO₂ was forced continuously through the VFC, where it is heated by burners for conversion of SO₂ to SO₃.

During a post idle period of operation, the burners were turned off so that no external heat was added to the system. It was observed that, as air continually passed through the VFC during a post idle period of sixteen hours, the temperature of the flowing air consistently rose rapidly from ambient temperature (90° F.) at the inlet of the VFC to an average temperature as high as 582° F. (in the range of 840° F. to 455° F.) at one section of the VFC, an increase of about 500° F.

This air flow temperature increase of such large magnitude and long duration following the initial input of heat from the burners clearly indicates that nuclear reactions were present in VFC. It was also found that the water vapor in the air stream completely disappeared in the VFC, because no sulfuric acid formation, which would have resulted from the reaction of water and SO₃, was detected.

It was determined that the water vapor in the air was initially converted to hydrogen and oxygen by the rapid heating, which further lead to nuclear reactions, involving transformation of hydrogen ions to protons. In the dynamic condition, electrons are driven off from their orbits, protons are produced from hydrogen ions, and other isotopes of hydrogen are formed from electrons, neutrons and protrons.

The mutual bombardments and direct impacts between the elements of the air produced various nuclear reactions including nuclear fusion which continued after the burners were shut off.

The following disclosure explains the phenomenon discovered during the course of the present invention and sets forth non-limiting practical applications of the present invention.

Many scientific accounts and tests undertaken in dynamic condition show discrepancies in results from that predicted by the current chemical reaction theory. In search of an explanation for the reasons of the discrepancy, the present inventor developed the Theory of Flux.

Lin's Theory of Flux has shown mathematically that when a fluid system is subjected to a high time rate of temperature change, the gas becomes very active chemically. The theory proves that a high time rate of temperature change creates a short dynamic condition that causes an increase of not only chemical reaction rate but also reaction product concentrations. The validity of the theory can be substantiated by many published scientific accounts and results and by the recently conducted pilot plant study discussed below.

Conventional chemical reaction processes, conducted at constant temperature and based on equilibrium theory, are inefficient and time-consuming. If industries can develop reaction processes that are based on the Lin's Theory of Flux, both time and energy can be greatly saved.

By the applying high time rate of temperature increase to a gas flow, nuclear reactions of the fluid can be promoted, and cold nuclear fusion has become a reality. The large amount of heat continuously generated by the resulting nuclear reactions in the flowing gas (gas flow) can be utilized for space heating, power generation, desalination, and other practical applications.

Current practice for nuclear reaction and fusion development which employs very high temperatures and static conditions proves not only uneconomical but also impractical. These shortcomings can be eliminated by the use of Lin's Theory of Flux to create a dynamic condition.

A new inexhaustible natural source of energy, involving air, water, and possibly hydrogen, is waiting for development to supply the huge demand of ever increasing world population.

Current Chemical Reaction Theory

Current chemical reaction theory, according to Vincenti and Kruger (Physical Gas Dynamics, Wiley, New York, 1965), is based on thermodynamic equilibrium, which includes mechanical, thermal and chemical equilibriums. Classical thermodynamics can predict only about states of thermodynamic equilibrium. The state of a gas system is represented by its temperature, pressure, and concentration. When a process is governed by classical thermodynamics, it must be regarded as consisting of a succession of states of thermodynamic equilibrium. The change of states is assumed to proceed very slowly or smoothly. In general, the current chemical reactor design is based on constant reactor temperature.

The following chemical equilibrium reaction is used as an example for explanation:

A+B⇄C (1)

where A and B are reactants and C is product

The reaction rate relation is as follows:

$$\frac{ⅆ [ C ]}{ⅆ t} = {K}_{1} [ A ] [ B ] - {K}_{2} [ C ] \qquad ( 2 )$$

where K₁ and K₂ are reaction rate constants, [C] is product concentration, and [A] and [B] are chemical reactant concentrations.

In an equilibrium chemical reaction, the forward reaction coexists with backward reaction. The backward reaction has a canceling effect upon the chemical reaction and the production of [C]. It performs useless work (negative) and thus wastes both time and energy. When product concentration reaches equilibrium concentration, the forward reaction rate is equal to the backward reaction rate, and there is no possibility for product concentration [C] to penetrate beyond equilibrium concentration. Therefore, the product yield is low.

The aforementioned disadvantages can be eliminated by subjecting the fluid to a rapid time rate of energy change, so that the reactions are changed from equilibrium to non-equilibrium conditions. Under a non-equilibrium condition, only the forward reaction exists. The conversion is based on Lin's Theory of Flux, which is described below.

Lin's Theory of Flux

The transmission of energy in wave form is hereby called flux. There are several different types of flux, such as heat flux, electromagnetic flux, etc., depending on the frequency of the wave form. In the development of the Lin Theory of Flux, the inventor uses heat flux for illustrative purposes.

When a gas system is subjected to a rapid time rate of temperature change, the system enters into a short dynamic condition. The velocities of its molecules, atoms, and electrons will also be changed continuously. As a result, frequencies and impact of molecular collisions will be changed, bonds between atoms ruptured or established, and electrons caused to leave their orbits or be captured. Therefore, the fluid becomes very active chemically for the required reaction.

1. Mathematical proof

At the electron, atomic and molecular levels, as net heat is added to a gas system, the net heat is immediately transformed to enthalpy, which is the sum of internal energy of its components and pressure of the gas. Mathematically, it can be expressed as follows:

Q=F(U,P)* (3)

Where:

Q=Total net heat added to a gas system

F(U,P)=functional equation.

U=Total internal energy of a gas system which is the sum of the kinetic and potential energies of the components of the system [components herein meaning molecules, atoms and electrons].

P=pressure of the gas.

* Other engineers separate F(P) from F(U).

The functional equation (3) can also be expressed as:

Q=F{KEₘ,PEₘ,KEₐ,PEₐ,KEₑ,PEₑ,P} (4)

Where:

$$\begin{matrix}Where : {KE}_{m} = Total kinetic energy of gas molecules in the gas system \\ = Σ 1 / 2 {m}_{m} {v}_{m}^{2}\end{matrix}$$

PEₘ=Total potential energy of gas molecules in the gas system. For a system such as a reactor of constant volume, it is a constant, k.

KEₐ=Total kinetic energy of all the atoms or nuclei (for plasma fluid) in the gas system=Σ½mₐvₐ²

PEₐ=Total potential energy of all the atoms or nuclei (for plasma fluid) in a gas system=Σmₐrₐ

$$\begin{matrix}{KE}_{e} = Total kinetic energy of all the electrons in the gas system \\ = Σ 1 / 2 {m}_{e} {v}_{e}^{2}\end{matrix}$$

PEₑ=Total potential energy of all the electrons in the gas system=Σmₑrₑ

mₘ, mₑ, mₐ are mass of individual molecule, electron, atom or individual nucleus in plasma fluid, respectively

vₘ, vₑ, vₐ are velocity vector of individual molecule, electron, atom or individual nucleus in plasma fluid, respectively

rₐ=interatomic distance or relative position vector of atoms

rₑ=distance of individual electron from the nucleus or position vector of the electron with respect to the nucleus in an atom

Differentiating the functional equation (4) with respect to time, t, results in the following expression:

$$\frac{ⅆ Q}{ⅆ t} = \frac{ Q}{ {KE}_{m}} ( Σ {m}_{m} {v}_{m} {a}_{m} ) + \frac{ Q}{ {KE}_{a}} ( Σ {m}_{a} {v}_{a} {a}_{a} ) + \frac{ Q}{ {PE}_{a}} \{ Σ {m}_{a} ( ⅆ {r}_{a} / ⅆ t ) \} + \frac{ Q}{ {KE}_{e}} ( Σ {m}_{e} {v}_{e} {a}_{e} ) + \frac{ Q}{ {PE}_{e}} \{ Σ {m}_{e} ( ⅆ {r}_{e} / ⅆ t ) \} + \frac{ Q}{ P} \frac{ⅆ P}{ⅆ t} \qquad ( 5 )$$

Equation (5) shows that the time rate of net heat added to the gas system, dQ/dt, is accompanied by the creation of aₘ, aₐ, drₐ/dt, aₑ, drₑ/dt, and dP/dt, where:

aₘ=acceleration vector of an individual molecule in the direction of vₘ

aₐ=acceleration vector of an individual atom relative to another atom in a molecule or that of an individual nucleus in a plasma fluid. The direction of aₐ agrees with that of vₐ

drₐ/dt=time rate of change of relative position vector of the atoms in a molecule

aₑ=acceleration vector of an individual orbiting electron in the direction of vₑ

drₑ/dt=time rate of change of relative position vector between an individual electron and the nucleus

dP/dt=time rate of change of pressure

From Eq (5), it is evident that the higher the time rate of the net heat added to or withdrawn from the system, the higher are the magnitudes of aₐ, aₘ, aₑ, drₐ/dt, drₑ/dt, and dP/dt. The aforementioned magnitudes can be positive or negative, depending on whether heat is added or withdrawn.

2. Effects of Time Rate of Net Heat (dQ/dt) Applied to a Fluid System

The effects of the aforementioned accelerations, aₘ, aₐ and aₑ, time rate of change of relative positions of atoms and electrons, drₐ/dt and drₑ/dt, and time rate of change of pressure, dP/dt, on chemical reaction rates are explained as follows:

2A. At the Electron Level

The orbital electrons are subject to tangential acceleration aₑ when heat flux is changed rapidly.

The tangential acceleration causes the velocity or the total energy (potential and kinetic) of an orbital electron to change. As a result, if dQ/dt in the gas system or aₑ is high enough, the velocity of orbiting electron can be accelerated to escape velocity, vₑₛₚ. The formula for vₑₛₚ calculation can be found in classical mechanics.

Because of the removal of electrons, the atom or molecule is ionized, and the ionized particles are very active chemically. If most or all of the electrons leave their orbits, the gas fluid becomes a plasma which is very active chemically.

aₑ and drₑ/dt can result in changing from bonding orbit to antibonding orbit, or vice versa. They may cause capture or release of electrons from atoms or molecules and help to establish or break the bonds, depending on the chemical reaction required.

The term drₑ/dt represents time rate of change of potential energy of the electron. When there is no heat added to the gas system, the potential energy of an electron is a function of its kinetic energy—as kinetic energy is increased, its potential energy is decreased.

However, in a dynamic system where heat is rapidly increased, drₑ/dt is the time rate of change of the position vector from center of nucleus to the electron; therefore, it is also equal to the instantaneous velocity which is tangent to the orbit of the electron. This variable velocity helps to move the electron from one orbit to another and boost the energy level of the electron. Evidently, dQ/dt can contribute to an increase of total energy of the electron. When dQ/dt is high enough, it can cause ionization of the particles (atom or molecule), or change the gas fluid to plasma state.

2B. At the Atomic level

At the atomic level, the sign of acceleration, aₐ of an atom is affected by dQ/dt. aₐ increases or decreases the magnitude of the relative atomic velocity, vₐ, of an atom with respect to other atoms in a molecule, but does not affect its direction. Since aₐ can change vₐ, it can in turn magnify the vibrational, rotational effects of the atoms in a molecule. Therefore, the molecule will expand and contract at higher frequency and its atoms spin at a faster rate of rotation. When the kinetic energy of an atom is raised to above the bonding energy of atoms in a molecule, the molecule splits.

If the particle is a nucleus in a plasma fluid, it moves freely without bonding. A high time rate of temperature increase of the fluid will cause acceleration aₐ of the nucleus which continuously changes the magnitude of vₐ but not its direction. The collision of the high speed nuclei can induce nuclear fusion and other nuclear reactions.

The rate of change of potential energy of atoms can be represented by drₐ/dt. drₐ/dt has the effect of establishing or disrupting the atomic bonds. drₐ/dt indicates that the equilibrium distance between two atoms is increased by the sudden application of heat to the system, thereby the potential energies of the atoms also increased. The increase of the inter-atomic distance tends to weaken the bonds between atoms. The atoms with weakened bonds are chemically more active to establish bonds with other atoms.

2C. At the Molecular Level

At the molecular level, when net heat is added to the gas system, if dQ/dt is positive, the gas molecule is accelerated by aₘ which is in the same direction as the gas molecular velocity before being accelerated, according to the concept of vectors. The increase of gas molecular velocities will cause an increase of the number of collisions per unit time of the gas molecules, an increase of the momentums of the molecules before impact, and the impact forces during the impact. As a result, aₘ is able to enhance chemical reaction rates of gas molecules.

In a closed gas system ( [symbol] Q/ [symbol] P) and dP/dt are positive values if time rate of temperature change dT/dt is a positive value. Therefore, the last term of equation (5), ( [symbol] Q/ [symbol] P)×(dP/dt) is a positive value if the time rate of temperature change, dT/dt, is a positive value. It is known that for a given gas mass, the higher the gas pressure, the closer the intermolecular distances between molecules, resulting in a higher reactivity.

From the aforementioned explanation, it is obvious that, when a gas system is subjected to a high time rate of temperature increase, the activity of its molecules, atoms and electrons is increased: velocities of molecules, electrons, atoms or nuclei are changed; frequencies and amplitudes of electron and atomic vibrations in a molecule increase; average kinetic energy of electrons, atoms, molecules increases; electrons are caused to leave their orbits, atomic bonds are ruptured, and the gas becomes very reactive chemically. The acceleration of nuclei in the dynamic condition can lead to nuclear reactions.

When a gas is subjected to a heat flux rate, the total heat flux rate is distributed among molecules, atoms or nuclei, and electrons. The average energy in each particle group increases with time, and when the energy of a particle (molecule, atom, nuclei or electron) reaches its activation level, reaction takes place. The reaction can be an atom-splitting reaction, a molecular built-up reaction or a nuclear reaction such as cold fusion.

3. Principle of Conversion To Non-equilibrium Reaction

The current chemical reaction theory based upon thermodynamic equilibrium is workable when the time rate of temperature increase is small. It ignores, however, the effect on reaction rate from a high rate of energy increase to a system. In other words, dT/dt, has not been considered. When dT/dt is high, its effect on a chemical reaction can not be ignored.

A chemical reaction can be changed from equilibrium to non-equilibrium condition, causing an increase of reaction rate and product concentration. When a gas system is subjected to a high time rate of energy increase, all the equilibriums are destroyed. A non-equilibrium condition suddenly emerges. During this short dynamic period, the newly created momentum forces the concentration of a resulting product to exceed equilibrium concentration. In a dynamic condition, the chemical reaction has only one direction, i.e. toward the production of the final product.

It has been proved mathematically, that, for the type of reaction wherein the chemical reaction rate increases with increase of temperature, the rate can be increased by high time rate of temperature increase; for the type of reaction wherein the rate increases with decrease of temperature, the rate can be increased by high time rate of temperature decrease.

In a static (adiabatic) condition, chemical reaction rates typically are dependent on temperature. Generally, there are three types of temperature dependent chemical reactions that the Theory will affect, namely:

Type 1 chemical reactions wherein the chemical reaction rate increases with an increase of temperature;

Type 2 chemical reactions wherein the chemical reaction rate increases with an increase of temperature in one temperature range, and increases with a decrease of temperature in another temperature range; and

Type 3 chemical reactions wherein the chemical reaction rate increases with a decrease of temperature.

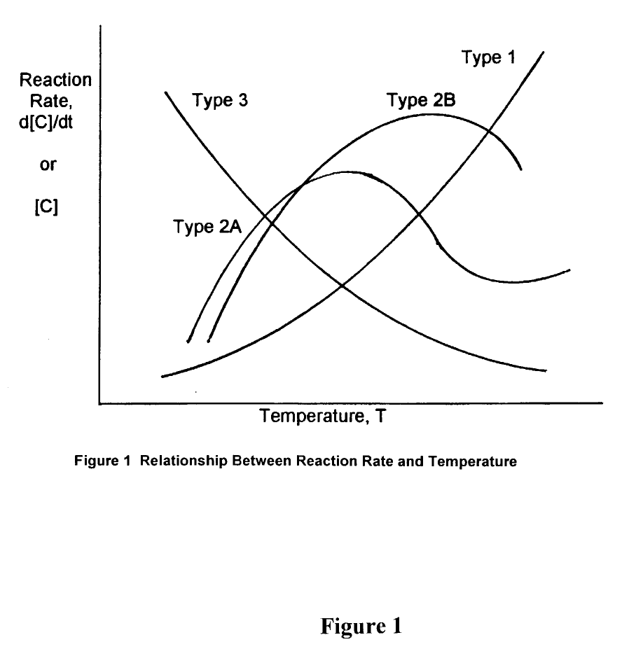

Each of these reaction types are depicted in FIG. 1.

The following are just a few illustrative reactions that are represented in FIG. 1:

N₂+O₂→2NO at high temperature region (type 1)

2NO+O₂→2NO₂ at low temperature region (type 3)

The production of polyethene is an example of a type 2A reaction.

The reaction of oxidation of SO₂ to SO₃ is an example of a type 2B reaction. For the oxidation of SO₂ to SO₃ the shape of the graph is dependent on SO₂ concentration. In general, below 900° F., the reaction rate increases with increases of temperature.

Lin's Theory of Flux and Nuclear Reactions

Experimental Proof by Pilot Plant Studies

In order to verify that nuclear reactions can be initiated by Lin's Theory of Flux, a pilot plant experiment was contracted out to Arcadis Geraghity & Miller (AGM). In close consultation with the inventor, AGM conducted a series of tests using a vertically fired combustor (VFC). The experiment was conducted at EPA's Experimental Research Center in Research Park, N.C. The objectives of the experiment is designed to show that the temperature of the gas fluid increases greatly after it passes through the system which does not have any heat added, and to verify that SO₂ can be oxidized to SO₃ by a high time rate of temperature increase.

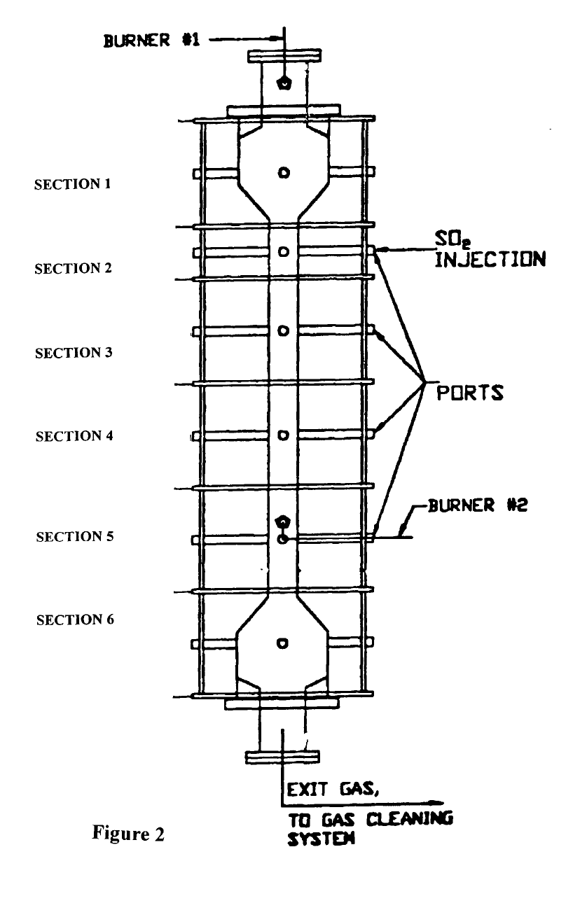

The VCF was refractory lined and had an inner diameter of 6 in. It was equipped with a number of access ports for insertion of measurement probes. FIG. 2 shows a sectional view of the VFC.

Two torch burners were used, namely burner #1 at the top of the combustor, and burner #2 at port No. 5. By manipulation of air to fuel ratio, the top burner #1 produced a combustion gas having a temperature of about 500° F. Sulfur dioxide gas was injected into section 2 to produce the desired SO₂ concentrations. Burner #2 injected natural gas into the combustor at different times according to the designed sequence and procedures.

Flue gas components were measured using a series of continuous emission monitors (CEM) for O₂, CO₂, CO, SO₂. The different temperatures along the length of the combustor were also measured using a number of thermocouples. Both CEM and thermocouple measurements were recorded at approximately 5-second intervals throughout the test using a computerized data acquisition system.

The gases from the VFC passed through a small heat exchanger to reduce the flue gas temperature, then to a pilot scale spray dryer for control of acid gases, followed by a fabric filter for removal of particulates.

Tables 1, 2, 3, 4 are the tabulated testing results for the aforementioned objectives.

1. Proof of Conversion of SO₂ to SO₃ by Rapid Temperature Increase

With reference to FIG. 1, pure SO₂ was injected continuously at section 2 and mixed with the gas flowing downward in the combustor. Original SO₂ concentration in the mixed gas is 5030 ppm. The natural gas flow to burner #1 was shut off at 13:21. The temperatures recorded at different sections are due to the heat remaining in the combustor wall after 13:21 and the heat released from the exothermic reaction.

Table 1 shows that SO₂ can be oxidized to SO₃ by rapid temperature increase of the SO₂. Among the limited testing results, the best SO₂ conversion to SO₃ efficiency was 85.1%, measured at the sampling point at section 6. The sulfur dioxide concentration was reduced from 5030 ppm to 750 ppm.

It is known that, in the absence of a catalyst, SO₂ appears to be unreactive with O₂ at constant temperatures. A catalyst has no effect on the equilibrium composition of a reaction mixture; it merely speeds up the attainment of equilibrium.

TABLE 1
Testing Results of Gas Temperature rise
due to Dynamic Chemical Reactions

| | | | | | | Temp. | |
|---|---|---|---|---|---|---|---|
| Time | | | | | | Increase | % |
| Aug. | | Section | Section | Section | Section | at | SO₂** |
| 27, | | T₃ | T₄ | T₅ | T₆ | Section | conver- |
| 1999 | Qₜ* acfh | (° F.) | (° F.) | (° F.) | (° F.) | 5 (° F.)⁺ | sion |
| 14:00 | 928 | 439 | 394 | 612 | 453 | 522 | 81.3 |
| 14:05 | 927 | 438 | 392 | 601 | 459 | 511 | 85.1 |
| 14:30 | 903 | 433 | 390 | 554 | 439 | 464 | 48.3 |
| 14:35 | 902 | 432 | 390 | 553 | 438 | 463 | 48.3 |
| 14:45 | 896 | 432 | 388 | 541 | 432 | 451 | 47.9 |
| 14:50 | 890 | 434 | 391 | 565 | 444 | 475 | 49.1 |
| 14:55 | 888 | 429 | 386 | 526 | 425 | 436 | 49.9 |
| 17:25 | 844 | 406 | 369 | 459 | 375 | 369 | 24.1 |

*Average flow rate between sections 4 and 6
⁺Ambient air temperature at entrance of the combustor was 90° F.
**Based on 5020 ppm of original SO₂ concentration at point of injection at section 2

2. Proof of the High Gaseous Temperature Increase due to Nuclear Reactions in the Dynamic Conditions

During an idle period of operation after 16:40, Aug. 26, 1998 (following operation of the VFC to oxidize SO₂ to SO₃), burners #1 and #2 were turned off so that no external heat was added to the system. It was observed that, as the air passed through the VFC during an idle period of sixteen hours as shown in Tables 2, the temperature of the flowing air consistently rose up rapidly from ambient temperature (90° F.) at the inlet of the VFC to an average temperature as high as 582° F. (in the range of 840° F. to 455° F.) at one section of the VFC, an increase of about 500° F. The temperature increase of such high magnitude and such long duration of the flow clearly indicates that nuclear reactions are present in VFC.

On Aug. 27, 1998, after the completion of SO₂ conversion to SO₃ testing, the burners in the combustor were turned off at 13:21 while an air of 510 scfh continuously passed through the VFC. The temperatures of the flowing air at different sections of VFC were measured after 14:00 and recorded in Table 3. During more than three hours observation, the temperature of the air rose from an ambient temperature of 90° F. to an average temperature of 525° F. with a range of from 612° F. to 459° F., or a temperature increase that ranged of from 521° F. to 369° F. Such a high magnitude of temperature increase verifies that nuclear reactions played an important role.

TABLE 2
Testing Results of Gas Temperature rise due to Dynamic Chemical
Reactions***

| | | | | | | Temp⁺. |
|---|---|---|---|---|---|---|
| | | Section | Section | Section | Section | Increase at |
| Time Aug. | | T₃ | T₄ | T₅ | T₆ | Section 5 |
| 26, 1998 | Qₜ* acfh | (° F.) | (° F.) | (° F.) | (° F.) | (° F.) |
| 16:40 | 2295 | 709 | 606 | 840 | 775 | 750 |
| 17:00 | 2134 | 699 | 596 | 780 | 730 | 690 |
| 18:00 | 2027 | 677 | 573 | 697 | 662 | 607 |
| 19:00 | 1969 | 659 | 558 | 657 | 619 | 567 |
| 20:00 | 1922 | 643 | 544 | 631 | 587 | 541 |
| 21:00 | 1884 | 628 | 532 | 609 | 559 | 519 |
| 22:00 | 1853 | 614 | 520 | 590 | 536 | 500 |
| 23:00 | 1827 | 601 | 509 | 573 | 515 | 483 |
| 24:00 | 1794 | 587 | 498 | 557 | 496 | 467 |
| AUG. 27, | 1783 | 582 | 494 | 550 | 488 | 460 |
| 1998 0:30 | | | | | | |
| 1:00 | 1768 | 575 | 488 | 542 | 479 | 452 |
| 2:00 | 1743 | 563 | 478 | 529 | 464 | 439 |
| 3:00 | 1722 | 551 | 469 | 516 | 449 | 426 |
| 4:00 | 1702 | 538 | 460 | 505 | 436 | 415 |
| 5:00 | 1680 | 526 | 450 | 493 | 423 | 403 |
| 6:00 | 1660 | 513 | 440 | 481 | 411 | 391 |
| 7:00 | 1642 | 501 | 432 | 470 | 399 | 380 |
| 8:00 | 1623 | 490 | 423 | 460 | 389 | 370 |
| 8:30 | 1612 | 483 | 418 | 455 | 383 | 365 |
| DIFFER- | 683 | 226 | 188 | 385 | 392 | 385 |
| ENCE** | | | | | | |
| AVERAGE | 1830 | 594 | 506 | 582 | 525 | 492 |

*Average flow rate between sections 4 and 6
**Difference between the extreme values in the range
⁺Ambient air temperature at entrance of the combustor was 90° F.
***Burner #2 was turned off at 16:09, and burner #1 was turned off at 16:30 Aug. 26, 1998. The total airflow was 955 scfh

TABLE 3
Testing Results of Gas Temperature rise due to Dynamic Chemical
Reactions***

| | | | | | | Temp. | % |
|---|---|---|---|---|---|---|---|
| Time | | | | | | Increase | |
| Aug. | | Section | Section | Section | Section | at | SO₂** |
| 27, | | T₃ | T₄ | T₅ | T₆ | Section | conver- |
| 1998 | Qₜ* acfh | (° F.) | (° F.) | (° F.) | (° F.) | 5 (° F.)⁺ | sion |
| 14:00 | 928 | 439 | 394 | 612 | 453 | 522 | 81.3 |
| 14:05 | 927 | 438 | 392 | 601 | 459 | 511 | 85.1 |
| 14:30 | 903 | 433 | 390 | 554 | 439 | 464 | 48.3 |
| 14:35 | 902 | 432 | 390 | 553 | 438 | 463 | 48.3 |
| 14:45 | 896 | 432 | 388 | 541 | 432 | 451 | 47.9 |
| 14:50 | 890 | 430 | 387 | 531 | 427 | 441 | 49.1 |
| 14:55 | 888 | 429 | 386 | 526 | 425 | 436 | 49.9 |
| 15:00 | | 428 | 385 | 522 | 422 | 432 | |
| 15:30 | | 424 | 381 | 500 | 408 | 410 | |
| 16:00 | | 420 | 378 | 486 | 399 | 396 | 31.3 |
| 16:30 | | 416 | 374 | 474 | 389 | 384 | |
| 17:00 | | 411 | 371 | 465 | 381 | 375 | |
| 17:25 | 844 | 406 | 369 | 459 | 375 | 369 | 24.1 |
| Aver- | 426 | 383 | 525 | 419 | 435 | | |
| age | | | | | | | |

*Average flow rate between sections 4 and 6
⁺Ambient air temperature at entrance of the combustor was 90° F.
**Based on 5020 ppm of original SO₂ concentration at point of injection at section 2
***Burner #2 natural gas flow was shut off at 13:21. No natural gas flow for the burner #1. The total airflow rate is 510 scfh

2A. The Rapid Temperature Rise in VCF is not Due to the Heat Released from Oxidation of Sulfur Dioxide

The high gas temperature increase is clearly not due to SO₂ conversion to SO₃ alone, for the temperature increase is far above the heat released from the conversion of the small concentration of SO₂ to SO₃. It can therefore be conclude that the high gas temperature increase is due mainly to other reactions.

2B. The Rapid Temperature Rise in VCF is Mainly Due to Nuclear Reactions

The heat released from chemical reactions, involving change of bonds, change positions of electrons, is not significant. According to Einstein, energy and mass are related by the equation

E=mc²

For a typical burning of carbon in oxygen, the energy lost is −393.5 kJ/mole, equivalent to −4.37×10⁻¹² kg/mole which can not be measured by a good analytical balance.

On the other hand, the heat released from nuclear reactions is very significant. The mass changes in nuclear reactions are about a million times larger per mole than those in chemical reactions. The continuously rapid increase of the temperature of the gas flow is apparently due to nuclear reactions.

2C. Hydrogen Production from Water by Rapid Heating

Hydrogen concentration in ambient air is very low, only 0.5 ppm. Such low concentration does not have any practical value in nuclear reaction development. It can be proven that hydrogen can be produced from water vapor by rapid heating by the following experiment:

Referring to the VFC in FIG. 2, the testing procedures are briefly described as follows:

(1) Burner #1 was turned on. This set up the baseline conditions for burner #2. The gas sample for the continuous monitors (CEMs, for O₂, CO₂, CO and SO₂) was taken at 11:10, Aug. 26, 1998 from the outlet of heat exchanger which is connected by a 4-in pipe approximately 40 feet from section 6 of the combustor.

(2) A stable flame was initiated with burner #2 at section 5 (without secondary combustion air due to the fact that the addition of secondary combustion air extinguished the burner #2 flame; the oxygen of the #2 burner is derived from the gas flowing from the #1 burner). Burner #2 served as a flame impinger. The combustor was allowed to equilibrate for more than three hours before the data were taken at 15:35, Aug. 26, 1998. The CEMs sampling was taken at section 7 at the heat exchanger outlet.

(3) The CEMs sampling probe was switched at 15:52, Aug. 26, 1998 from the heat exchanger outlet to the outlet of section 6 at the bottom of the combustor and the compositions of the gas therein were automatically recorded.

Testing Results

The data obtained from the above experiment is presented in Table 4 below. This data clearly shows that the Lin's Theory of Flux and the principle of conversion to non-equilibrium reaction are valid. From Table 4, it can be concluded that flue gas in ductwork is in a dynamic condition. The chemical compositions of the gas are not uniform; they change from section to section due to rapid temperature change. For a single type of reaction, changing the sign of time rate of temperature change can change a forward reaction to backward reaction.

The data in Table 4 shows that as the temperature of flue gas is rapidly increased between sections 4 and 6, SO₂ concentration is decreased by 1570 ppm, or same SO₃ concentration increased.

On the other hand, when the temperature of flue gas is rapidly decreased between sections 6 and 7, SO₂ concentration increased from 3,450 ppm at section 6 to 5,120 ppm at section 7, an increase of 1570 ppm.

From the data in Table 4 it can be seen that 1,570 ppm SO₂ is converted to SO₃ from sections 4 to 6. If water is present in the gas, SO₃ will immediately react with water to form sulfuric acid which can not be reverted to SO₂ by cooling. The fact that SO₂ concentration increased from 3,450 ppm at section 6 to 5,120 ppm at section 7 is an indication that the increase is due to the presence of 1570 ppm of SO₃ at section 6 only

On the other hand, if moisture is present in the air in the combustor environment, the 1570 ppm SO₃ at Section 6 will be converted to sulfuric acid:

SO₃+H₂O→H₂SO₄

Once sulfuric acid is formed, the SO₃ that is removed from the air can never be reverted to SO₂. The aforementioned fact that SO₂ concentration increased from section 6 to section 7 is an indication that moisture is not present in the air in the combustor. Since ambient air always contains moisture, evidently, as the air enters the combustor, the rapid heating causes the water therein to disassociate to H₂ and O₂ as follows:

2H₂O→2H₂+O₂

The disintegrated element H₂ from H₂0 is the source of proton for nuclear reaction as explained below.

TABLE 4
Testing Results Showing Changes of Gas Composition
Due to High Rate of Temperature Changes in Ductwork

| | SECTION 4 | SECTION 5 | SECTION 6 | SECTION 7 |
|---|---|---|---|---|
| SECTION | (1) | (2) | (3) | (2) |
| Time Sample | Aug. 26, | Aug. 26, | Aug. 26, | Aug. 26, |
| Taken | 1998 11:10 | 1998 15:35 | 1998 15:52 | 1998 15:35 |
| Temp. | 724° F. | 1,402° F. | 1,317° F. | 350° F. |
| O₂ | 176,600 ppm | — | 62,000 ppm | 61,700 m |
| CO₂ | 17,400 ppm | — | 101,700 ppm | 84,600 ppm |
| CO | 646 ppm | — | 956 ppm | 416 m |
| SO₂ | 5,020 ppm | — | 3,450 ppm | 5,120 ppm |

2D. Nuclear Reactions in the Reactor

2D1. Production of Hydrogen from Water Vapor by Rapid Heating for Breaking Bonds

Production of hydrogen from water vapor by rapid heating dissociates water into H₂ and O₂ as follows:

H₂O→H₂+½O₂

2D2. Production of Deuterons from Hydrogen by Rapid Heating

The production of deuterons from hydrogen by rapid heating occurs according to the following steps:

a) Electrons are removed from their orbits around atoms in the gas to form a plasma fluid including removal of electrons from their orbits around hydrogen atoms to form protons as follows:

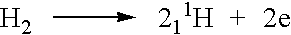

b) The collision between the accelerated positively charged protons and negatively charged electrons forms neutrons as follows:

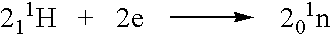

c) The collision between the accelerated protons and neutrons forms deuterons as follows:

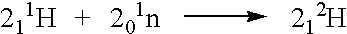

2D3. Nuclear Fusion, Plasma

Nuclear fusion is a nuclear reaction in which light nuclei combine to give a more stable, heavier nucleus plus possibly several neutrons, with a release of energy. The fusion reactions most likely to succeed in a reactor involve the isotopes of hydrogen as follows:

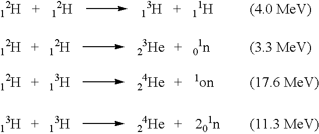

2D4. Bombardment by Acceleration of Protons, Helium, and Neutrons on Targets in Air Such as Nitrogen

The chance for possible nuclear reaction in air is between nitrogen and other light gases such as helium is great. Nitrogen is plentiful in air and helium concentration in air is about 5.24 ppm. Helium can be produced from fusion of protons as shown above. The nuclear reaction between nitrogen and helium is represented by the following nuclear reaction:

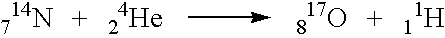

The emission of high-energy particles such as protons will cause further nuclear bombardment of light gases such as Li to induce more nuclear reactions and release more energy.

Rutherford observed that there were no nuclear reactions on oxygen and heavy gases such as carbon dioxide by the alpha-particle (He) bombardment.

2D5. Gamma Rays

Gamma rays often accompany the emission of alpha and beta particles. The absorption of gamma rays by the particles in the gas is accompanied by bond-breaking and reduction of gas temperature such as at section 4 of the combustor as shown in Tables 1, 2, and 3.

2D6. Perpetual Chain Reactions for Energy Production

The heat released from nuclear reaction can maintain the temperature of the gas flow in a dynamic condition, which causes the perpetual nuclear reactions to occur, with continuous release of heat. The system becomes a source of energy production, free from all forms of pollution.

2D7. Second Nuclear Reactions

From Tables 1, 2, 3, the temperatures in the reactor invariably decrease from sections 3 to 4, increase from sections 4 to 5, and then decrease from section 5 to 6. The high temperature increases of air flow at section 5 is due to second nuclear reactions induced by burner 2, from which the flame flows countercurrent to the air flow.

3. Practical Applications of Nuclear Fusion Reaction

3A. Basic Nuclear Fusion Unit for Heat Production

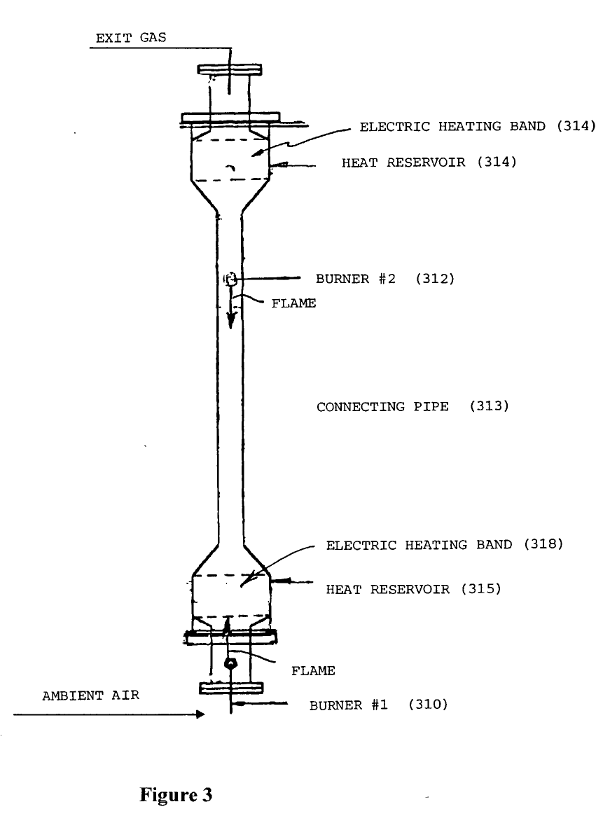

FIG. 3 is a schematic side view of a basic nuclear fusion unit according to one embodiment of the present invention.

Referring to FIG. 3, ambient air is first forced through Venturi mixer where it is optionally or selectively mixed with injected chemicals such as steam, methane, hydrogen, helium, etc. The mixed gas is then forced through the basic nuclear fusion unit 316.

Nuclear reaction can be induced in the basic nuclear fusion unit 316 by the use of burners, preferably two burners, one burner 310 (burner #1) at an upstream portion of the basic nuclear fusion unit 316 and a second burner 312 (burner #2) at a downstream portion of the basic nuclear fusion unit 316. The flame from the second burner 312 flows countercurrent with the direction of air flow. The heat released from nuclear reaction enables the temperature to remain at a high level in the basic nuclear fusion unit 316 and induces further nuclear reactions in the incoming fresh air. Therefore, the burners and heating bands are used for inducing nuclear reactions or to raise the reaction activities to higher levels. Once nuclear reactions are established, the burners can be withdrawn and/or turned off. In general, they are not used most of the time.

FIG. 3 shows that, at the inlet of the fusion unit, burner #1, 310, issues out flame in the direction of the flow at a distance upstream of the heat reservoir 315. The heated gas passes through the heat reservoir, 315, where a large portion of the heat in the flow is retained, and the nuclear fusion reactions in the flowing gas due to rapid heating produce additional heat which enhances further nuclear reactions continuously and rapidly in the flow. The heat reservoirs 314 and 315 have enlarged cross-sectional areas. The flue gas leaving from heat reservoir, 315, meets the countercurrent flame issuing out from burner #2, 312, where the second nuclear reaction is induced. More heat is generated by nuclear reaction at the section where burner #2 is located. The flue gas then passes though heat reservoir, 314, where a portion of the heat is retained. The heat reservoirs, 314 and 315, are covered by electric heating bands, 318, or provided with other supplemental heating means which supply heat to the reservoirs as needed at the time after the burners withdrawn. For long basic nuclear fusion units, more that one countercurrent burner can be used.

The two heat reservoirs, 314 and 315, are connected by connecting pipe, 313. The ratio of the cross-sectional area of heat reservoir and that of connecting pipe is preferably higher than 15.

The temperature of the gas leaving the basic fusion unit, 316, can be manipulated by several adjustments, such a concentration of the injected chemicals, intensity of the flames from the burners, flow velocity, number of counter-current burners used, and other means, to the desired level for performing its useful function that the unit, 316, is designed for.

3B. Practical Application of the Nuclear Reaction Induced by Rapid Heating or High Time Rate of Temperature Increase

3B1. Space heating

The nuclear reactions generate a large amount of heat. The rise of the temperature of the air passing through a nuclear fusion unit according to the present invention from ambient temperature to as high as 600° F. or more has been demonstrated. Such high levels temperature of the gases can be used to in central heating units for heating apartments, small communities, etc.

When the temperature of air from the basic nuclear fusion unit, 316, becomes too high, coolant injection can be used to bring the temperature down to a comfortable level before entering radiators or other heat exchangers or distributors.

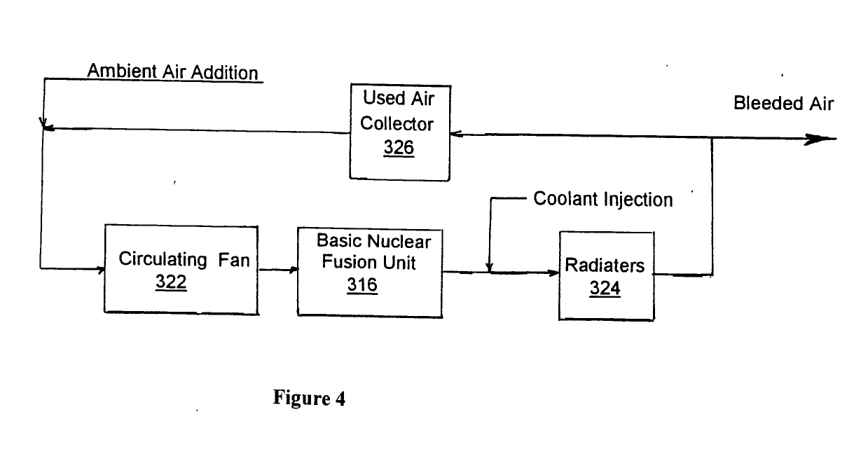

FIG. 4 is a schematic diagram of a general arrangement of nuclear fusion system for space heating. The arrangement or system includes one or more of the basic nuclear fusion units 316 depicted in FIG. 3. A circulating air fan 322 controls the flow of gases (recirculated and supplemental ambient air) into the basic nuclear fusion unit(s) 316. The heated gases exiting the basic nuclear fusion unit(s) 316 pass through one or more radiators 324 or other heat exchangers which distribute heat into a space such as a house or other building or dwelling to be heated. If necessary, the temperature of the heated gases exiting the basic nuclear fusion unit(s) 316 can be adjusted, i.e., lowered, by injecting a coolant gas therein as indicated. Alternatively, an auxiliary heat exchanger could be provided upstream of radiator(s) 324 to lower the temperature of the heated gases reaching the radiator(s) 324.

Heated gases exiting the basic nuclear fusion unit(s) can be recirculated and can be supplemented with ambient air or a portion can be bleed off as necessary and depicted in FIG. 3. It is also possible to inject moisture and other temperature-controlling gases into the gas fed into the basic nuclear fusion unit(s) as discussed herein.

4B2. Power Generation

1. Power Generation Improvement

Currently, the temperature at the top of commercial furnace is about 2,000° F. In order to make the energy generating process using rapid heating useful, valid, applicable to the currently used equipment, the target temperature must be 2000° F. As mentioned previously, on the per mole basis, the nuclear reaction can generate energy one million times than ordinary chemical reactions do. In order to achieve higher energy production of the system, the concentrations of the materials producing nuclear fusion reactions must be increased. It can be achieved by the following four methods:

a. Inject low-heat steam to the air before entering the basic nuclear fusion unit for increase of hydrogen production rate in the unit.

b. Inject methane to the air before it entering the basic nuclear fusion unit in order to increase the hydrogen concentration from splitting methane in the basic fusion unit.

c Inject hydrogen to the air before entering the basic nuclear fusion unit in order to increase the temperature of the air to 2000 degrees F. or higher at the exit of the unit.

d. Inject helium to the air before entering the basic nuclear fusion unit in order to increase the temperature of the air to 2000 degrees F. or higher at the exit of the unit.

e. Increase time rate of temperature change of the gas flow in the basic fusion unit by the Increase of heat input to the gas flow from the burner and that of gas flow rate.

f. Use more counter-current flame burners arranged in series along the basic fusion unit to induce more nuclear reactions, resulting in higher temperature at reactor outlet.

2. Nuclear Fusion Power Plants

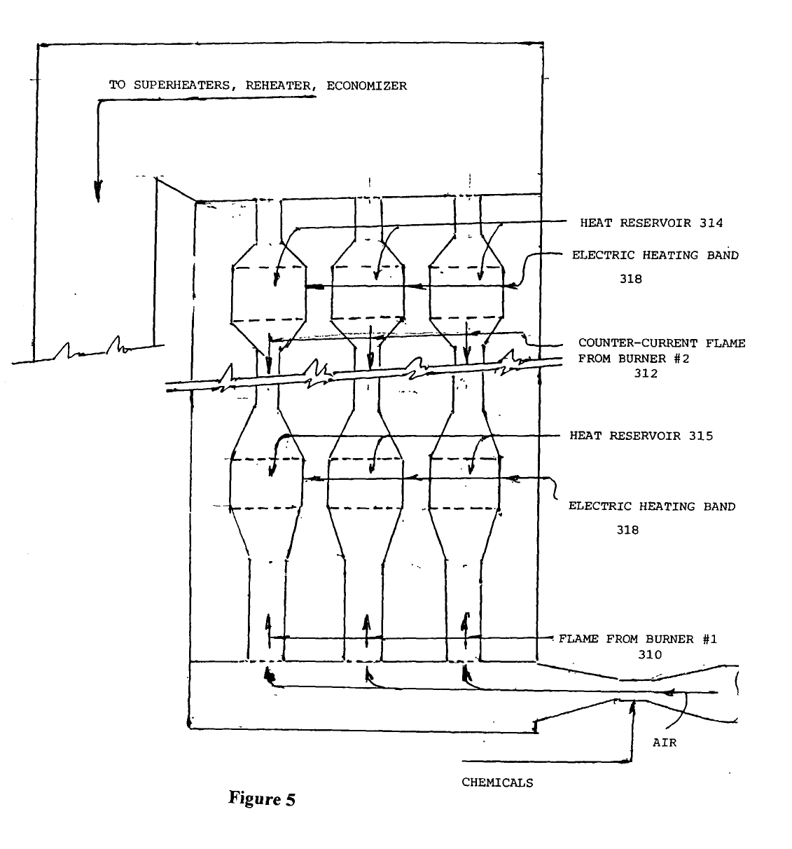

FIG. 5 is a schematic diagram of nuclear fusion boiler for a new power plant or for retrofitting existing power plants. The nuclear fusion boiler includes a bank or array of the basic nuclear fusion units exemplified in FIG. 3 above. In FIG. 5 elements that are common with the basic nuclear fusion unit of FIG. 3 are identified by common reference numerals for convenience and reference is accordingly made to FIG. 3 for a description of these common elements. Chemicals such as steam, methane, helium, are added to the ambient air at the venturi mixer 300. The mixed flow is continuously distributed to the basic nuclear fusion units 316 where fusion reactions cause large amounts of heat to be generated, resulting in a rapid increase of air temperature as it passes through the units. The high temperature air is collected and sent continuously to conventional superheaters, reheaters, and economizers (not shown) for power generation.

The basic nuclear fusion units in the boiler should be properly spaced so that workers can enter the boiler for performing maintenance work. They should also be strengthened structurally using suitable bracing.

The boiler, employing the basic nuclear fusion units can be placed vertically or horizontally, new or retrofitting, to suit local conditions and requirements.

4. Saline Water Conversion and Wastewater Treatment

On the earth, less than two percent of the total water available is suitable for human consumption. In many areas, because of rapid population increase, prolonged draught due to global warming, and intense sea water intrusion due to rising sea level, saline water conversion becomes an urgent solution for water supplies.

Saline water conversion can be easily achieved by evaporation, employing heat transfer, direct or indirect, by the heat from gas emission from a basic nuclear fusion unit according to the present invention. The evaporated steam is condensed out to form water suitable for human consumption. Problems associated with evaporator include corrosion and scale formation.

The basic problem of saline water conversion is cost of energy supply. With the development of the new nuclear fusion power, an inexpensive and inexhaustible energy supply becomes a reality. Many saline water conversion processes such as electrodialysis and reverse osmosis, can be used freely and economically.

4. Promote Chemical Reaction

The heat release from the chain fusion reaction in the basic nuclear fusion unit of the present invention can be used simultaneously to promote chemical reactions such as conversion SO₂ to SO₃ in the basic unit. The chemicals such as SO₂ is added to the air flow prior to entering the basic unit or injected to a predetermined section for desired time rate of temperature increase. The basic nuclear fusion unit actually serves as a chemical reactor that can be used for all type I reactions, namely, the reaction rate increases with increase of temperature.

The present invention is based upon the development of unique kinetics and mechanisms of nuclear fusion reactions, which offer an inexhaustible source of energy, and completely eliminate the pollutions, including air, water and solids, from fossil fuel combustion. The present invention does not involve huge radio-active waste disposal problems that plague our atomic power plants. The present invention satisfies the long-standing need for a commercially superior, pollution-free energy production process.

Although the present invention has been illustrated and described in connection with few selected examples and embodiments, it will be understood that they are illustrative of the invention and are by no means restrictive thereof. For example, the nuclear fusion process can be employed directly to operate machinery in the remote isolated area. Laser beam, electric arc, or any microwave signal of correct frequency can be employed to rapidly increase temperature or energy level of the particles in the flow. It is reasonable to expect that those skilled in this art can make numerous revisions and adaptations of the invention and it is understood that such revisions and adaptations are included within the scope of the following claims as equivalents of the invention.

What is claimed is:

1. A method of generating a nuclear reaction from a gas stream containing hydrogen atoms which comprises the steps of:
a) applying heat to the gas stream at a rapid rate sufficient to dissociate the water into hydrogen and oxygen and to transform hydrogen ions into protons to induce nuclear reactions;
b) terminating the application of heat to the gas stream; and
c) allowing nuclear reactions to continue in reactive species of the gas stream.

2. The method of generating a nuclear reaction according to claim 1, wherein the nuclear reactions in step c) include nuclear fusion.

3. The method of generating a nuclear reaction according to claim 1, wherein the gas stream comprises air.

4. The method of generating a nuclear reaction according to claim 1, wherein the rapid heating performed in step a) is performed by using at least one of a flame generator, a laser beam, an electric arc and a microwave generator.

5. The method of generating a nuclear reaction according to claim 1 further comprising the step of adding chemical species into the gas stream to increase at least one of the rate and the temperature of the nuclear reactions.

6. A method of generating heat which comprises the steps of:
a) providing a gas stream which includes water;
b) applying heat to the gas stream at a rapid rate sufficient to dissociate the water into hydrogen and oxygen and to transform hydrogen ions into protons;
c) terminating the application of heat to the gas stream;
d) allowing nuclear reactions to occur in reactive species of the gas stream; and
e) recovering heat from the nuclear reactions.

7. The method of generating heat according to claim 6, wherein the nuclear reactions in step d) include nuclear fusion.

8. The method of generating heat according to claim 7, wherein the gas stream comprises air.

9. The method of generating heat reaction according to claim 6, wherein the rapid heating performed in step b) is performed by using at least one of a flame generator, a laser beam, an electric arc and a microwave generator.

10. The method of generating heat according to claim 6 further comprising the step of adding chemical species that cause nuclear reactions into the gas stream to increase at least one of reactivities and the resulting gas temperature of the nuclear reactions.

11. The method of generating heat according to claim 6, wherein the recovered heat is used to achieve at least one of heating a building, produce electricity, desalinate salt water and promote chemical reaction along with the nuclear reactions in dynamic conditions.

12. A nuclear reactor which comprises:
a chamber having an upstream side and a downstream side;
a gas inlet at the upstream side;
a gas outlet at the downstream side;
means for flowing a stream of gas through the chamber from the upstream side to the downstream side;
first and second means to heat the gas stream flowing through said chamber at a sufficient rate to cause components of said stream of gas to undergo nuclear reactions, wherein the first means to heat the gas stream is upstream from the second means to heat the gas stream.

13. The nuclear reactor according to claim 12, wherein at least one of the first and second means to heat the gas stream flowing through the chamber comprises at least one of a flame generator, a laser beam, an electric arc and a microwave generator.

14. The nuclear reactor according to claim 13 wherein both the first and second means to heat the gas flowing through the chamber comprises flame generators which direct flames toward each other.

15. The nuclear reactor according to claim 12, further comprising additional means to heat the gas stream flowing through said chamber at a sufficient rate to cause components of said stream of gas to undergo nuclear reactions.

16. The nuclear reactor according to claim 13, wherein the chamber includes a heat reservoir near at least one of the upstream side and the downstream side.

17. The nuclear reactor according to claim 16, wherein the a heat reservoir is provided at both the upstream side and the downstream side of the chamber.

18. The nuclear reactor according to claim 16, wherein each heat reservoir is provided with a supplemental heating means.

19. The nuclear reactor according to claim 13 further comprising means to inject a chemical species for increasing nuclear reaction activities into the stream of gas flowing through the chamber to achieve a high temperature of the nuclear reactions.

20. A furnace for heating a building which comprises the nuclear reactor of claim 13.

21. A furnace according to claim 19 wherein comprises a plurality of the nuclear reactors of claim 13.

22. A furnace according to claim 21 in combination with a nuclear power plant.
